(19) United States
(12) Patent Application Publication
(10) Pub. No.: US 2026/0266337 A1
(43) Pub. Date: Sep. 10, 2026

(54) LABYRINTH SEALING SHIELD FOR A ROLLING BEARING AND ASSOCIATED ROLLING BEARING

(71) Applicant: Aktiebolaget SKF, Goteborg (SE)

(72) Inventors: Piero SANTANGELO, Torino (IT); Enzo AMICO, Moncalieri (IT); Riccardo RESTIVO, Torino (IT); Giuseppe SARDELLA, Pinerolo (IT)

(21) Appl. No.: 19/549,572

(22) Filed: Feb. 25, 2026

(30) Foreign Application Priority Data
Mar. 4, 2025 (IT) 102025000004482

(51) Int. Cl. F16C 33/80; F16C 19/06

(52) U.S. Cl. CPC F16C 33/80; F16C 19/06; F16C 2208/20; F16C 2208/70; F16C 2208/76

(57) ABSTRACT

A sealing shield (5) for a rolling bearing (1). The sealing shield includes an annular body (11) having a radially outer peripheral edge (12) which is rigidly coupled to an outer ring (2) of the bearing when in use. The annular body has a radially inner peripheral edge (13) of which provides a labyrinth seal with a radially outer lateral surface (14) of an inner ring (3) of the bearing and defining with the radially outer lateral surface a radial gap when in use. The annular body (11) is made entirely in one piece and of a synthetic non-elastomeric thermoplastic plastic material. The radially outer peripheral edge of the annular body is coupled by snap-fitting and in a substantially fluid-tight manner with an annular seat (10) formed radially on the inside of the outer ring (2) of the bearing.

### CROSS-REFERENCE TO RELATED APPLICATION

This application claims priority to Italian Patent Application No. 102025000004482, filed Mar. 4, 2025, the entirety of which is hereby incorporated by reference.

### FIELD

The present disclosure relates to a sealing shield that can be mounted on a rolling bearing to create a hydraulic labyrinth seal to protect the rolling elements of the bearing. The present disclosure also relates to an associated rolling bearing, equipped with such a sealing shield.

### BACKGROUND

All rolling bearings must be lubricated throughout their service life. For this purpose, the annular space housing the rolling elements and delimited between the inner and outer rings of the bearing have to be filled with lubricating grease and shielded or sealed towards the outside of the bearing to prevent lubricating grease from leaking out of the aforementioned annular space.

To seal lubricating grease by means of a shield, i.e. by means of a sealing device with no elastomer sliding lips, so as to obtain substantially zero friction in the sealing device, several solutions are known to enable a labyrinth seal to be made, depending on the geometry of the bearing. In all cases, however, the shield is always made from a metal material which is printed by blanking and plastic deformation, for example by coining. This involves a complex and expensive production process, which also requires a lot of energy and the use of chemicals.

The metal stamping process also generates a significant amount of waste material that can only be reused by recasting, resulting in significant CO₂ emissions, including relative to end-of-life disposal of the product.

Therefore, the technical problems posed by existing sealing shields for rolling bearings can be summarized as the high cost of the shield and high CO₂ emissions, first in the production process and then in end-of-life disposal.

There is therefore a technical need for a sealing shield for a rolling bearing, and an associated rolling bearing, in which the sealing shield can be designed to reduce production costs and environmental impact in terms of CO₂ emissions, while maintaining shielding performance comparable to that of the metal sealing shields in the prior art.

### SUMMARY

The present disclosure is therefore intended to provide a sealing shield for a rolling bearing and an associated rolling bearing which are free of the technical difficulties found in the prior art, and that in particular reduce the CO₂ footprint of both the production and end-of-life disposal thereof, while preserving good hydraulic sealing capacity and therefore high lubricating grease retention, ease of assembly and adequate robustness.

According to the present disclosure, a sealing shield for a rolling bearing and an associated rolling bearing are provided with the features set out in the attached claims.

In particular, a solution based on a shield made entirely of a synthetic plastic material is provided, the geometry of which has been modified compared to the known metal shields, maintaining the overall internal geometry of the metal shields, but limiting potential leakages by returning lubricating grease/oil to the sliding track for rolling elements formed on the inner ring of the bearing and a geometry able to produce an effective labyrinth seal.

### BRIEF DESCRIPTION OF THE DRAWINGS

The present disclosure is described below with reference to the attached drawings showing a non-limiting example embodiment thereof, in which:

FIG. 1 schematically illustrates an elevation view in radial section of a radial portion of a rolling bearing according to the present disclosure;

FIG. 2 schematically illustrates, on an enlarged scale, a perspective three-quarter front view of a sealing shield according to the present disclosure;

FIG. 3 schematically illustrates, on a further enlarged scale, a perspective view in radial section of a circumferential portion of the sealing shield in FIG. 2;

FIG. 4 schematically illustrates, on a further enlarged scale, the same perspective view as in FIG. 2 of a circumferential portion of the sealing shield according to the present disclosure;

FIG. 5 schematically illustrates, on a highly enlarged scale, a first detail of FIG. 1, showing a coupling between a radially inner peripheral edge of the sealing shield according to the present disclosure and an inner ring of the rolling bearing in FIG. 1; and

FIG. 6 schematically illustrates, on a highly enlarged scale, a second detail of FIG. 1, showing a coupling between a radially outer peripheral edge of the sealing shield according to the present disclosure and an outer ring of the rolling bearing in FIG. 1.

### DETAILED DESCRIPTION

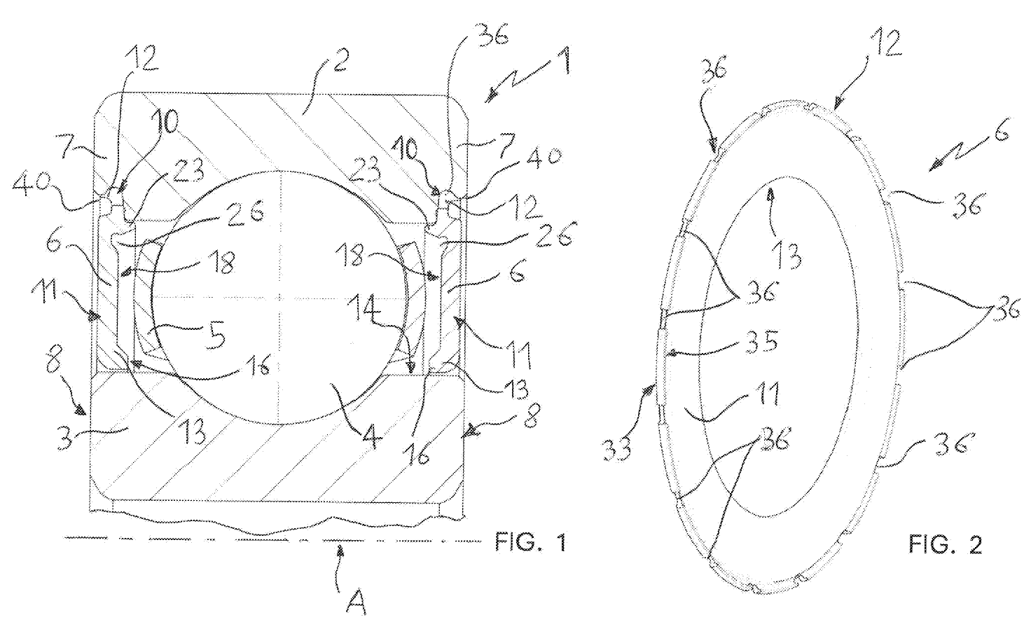

With reference to FIGS. 1, 5 and 6, the reference number 1 denotes, as a whole, a rolling bearing of a generally known type and comprising a radially outer ring 2, a radially inner ring 3, a plurality of rolling elements 4 interposed between the inner ring 3 and the outer ring 2 to make them relatively rotatable with each other with low friction, held in the correct position between the rings 2 and 3 by a known cage 5, preferably made of a synthetic plastic material, and at least one sealing shield 6 mounted interposed between the inner ring 3 and the outer ring 2 at opposite axial ends 7 of the outer ring 2, and opposite axial ends 8 of the inner ring 3.

In the non-limiting example shown, the rolling bearing 1 comprises a pair of opposing sealing shields 6, which are mirror-symmetrical, mounted at both pairs of ends 7 and 8 of the rings 2 and 3. It is clear that a single sealing shield 6 may be enough in some applications if the opposite ends 7 and 8 are otherwise protected, and that the following applies to any type of rolling bearing, with one or two rows of rolling elements 4, which may be balls, as in the example shown, or conical or cylindrical rollers.

The rolling bearing 1 has an axis A of symmetry (FIG. 1) which is also the axis of symmetry of the rings 2 and 3 and of the two sealing shields 6, which are annular.

The axial ends 7 of the outer ring 2 are each provided with an annular seat 10 configured to receive, with a static fluid-tight coupling and as will be shown, the sealing shield 6, which is usually constrained to rotate with the outer ring 2. The annular seats 10 are formed radially on the inside of the outer ring 2.

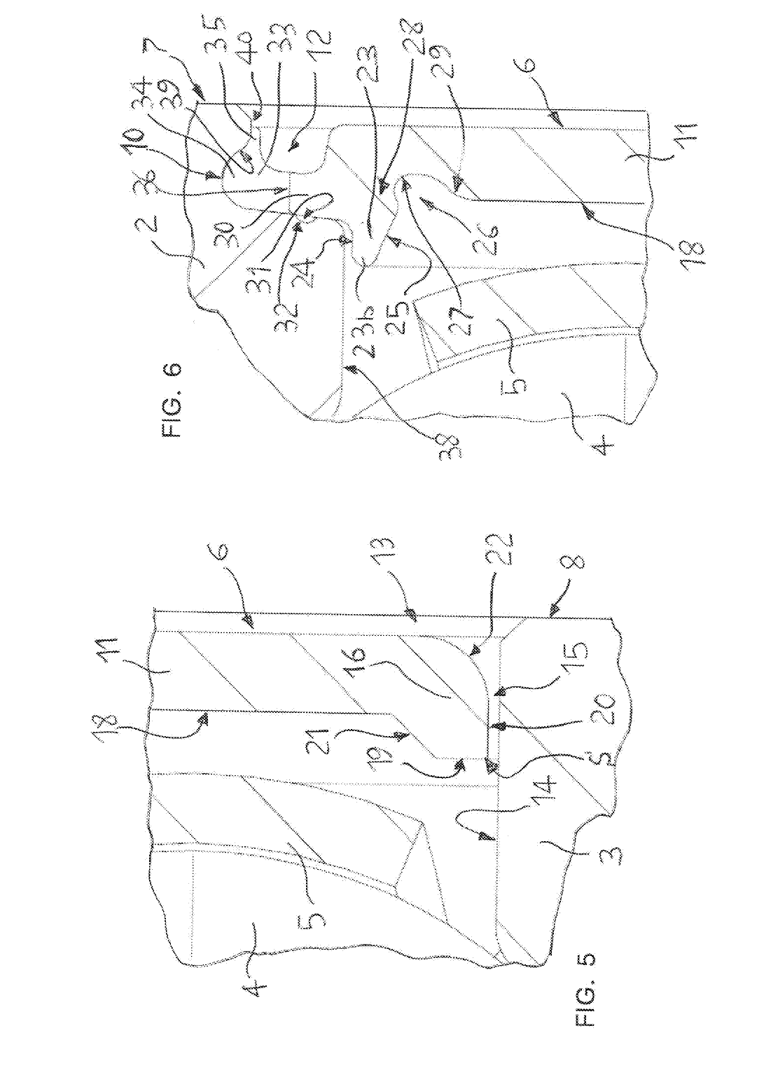

With particular reference to FIGS. 2, 3 and 4, the sealing shield 6 for the rolling bearing 1 comprises/consists of an annular body 11, in turn comprising a radially outer peripheral edge 12 configured to be rigidly coupled to the outer ring 2 when in use, and a radially inner peripheral edge 13 configured to provide, when in use, a labyrinth seal with a radially outer lateral surface 14 of the inner ring 3, defining a predetermined radial gap 15 with the lateral surface 14 (FIG. 5) constituting a contactless hydraulic labyrinth seal on the inner ring 3.

According to a first aspect of the present disclosure, the annular body 11, and therefore the entire sealing shield 6 formed thereby, is/are made entirely in one piece and of a single synthetic non-elastomeric thermoplastic plastic material.

The annular body 11 is substantially disk-shaped and is obtained by injection moulding of a synthetic non-elastomeric thermoplastic material selected from the following group: PP (polypropylenes), PBT (polybutylenes), TPC (polyesters), PA66, PA46 (polyamides) or similar in composition or performance. Preferably, the retaining cage 5 for rolling elements 4 is also made of a synthetic plastic material and, according to one aspect of the present disclosure, each sealing shield 6, i.e. each disk-shaped annular body 11 forming same, and the cage 5 are moulded from the same synthetic non-elastomeric thermoplastic material.

According to one aspect of the present disclosure, the dimensional ratios of the disk-shaped annular body 11 are preferably chosen so that the ratio between an axial thickness of the annular body 11 and its external diameter is between 1/50 and 1/30, in order to ensure an optimal compromise between the stiffness of the sealing shield 6 and the required flexibility of the annular body 11, as will be shown, to obtain simple and safe mounting in the seat 10. Generally, the axial thickness of the annular body 11 can vary between 0.8 mm and 1.5 mm.

The radially outer peripheral edge 12 is indeed configured to couple by snap-fitting in a fluid-tight manner, as will be shown, with the annular seat 10 formed radially on the inside of the outer ring 2 of the bearing.

According to one aspect of the present disclosure, the radially inner peripheral edge 13 has a radially inner portion 16 which is axially curved so as to protrude axially cantilevered from a substantially flat first face 18 of the annular body 11 and the sealing shield 6, oriented, when in use, towards a space inside the bearing 1 delimited between the inner ring 3 and the outer ring 2 and housing the rolling elements 4 and the cage 5.

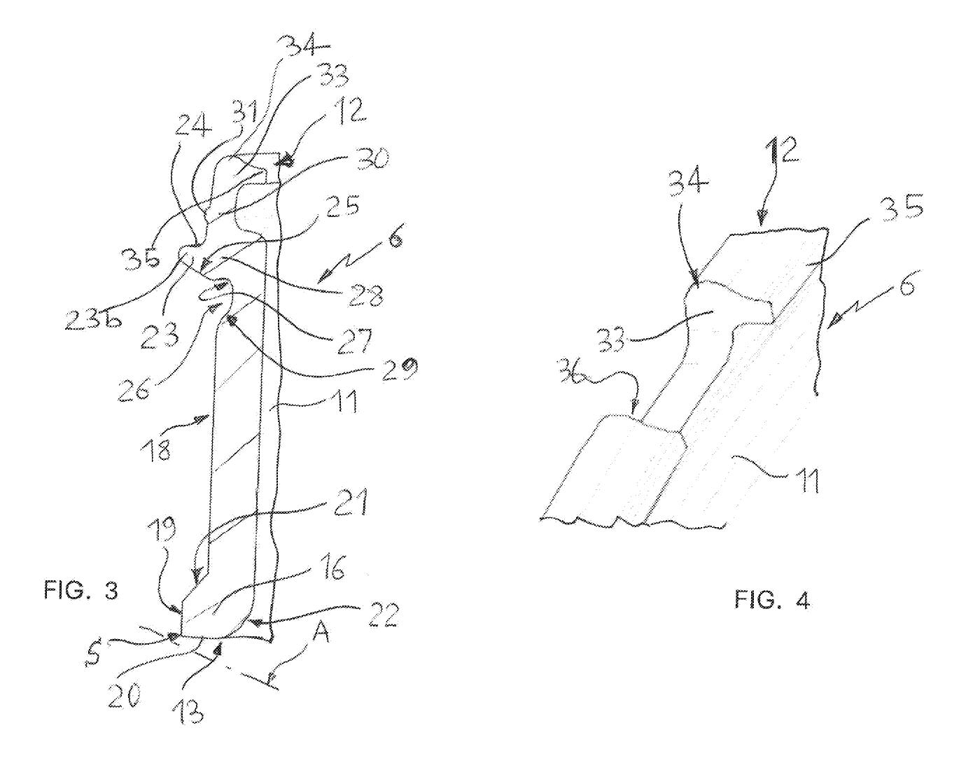

According to one aspect of the present disclosure (FIGS. 3 and 5), the radially inner axially curved portion 16 of the radially inner peripheral edge 13 of the annular body 11/sealing shield 6 is delimited, on the same side as the face 18 and radially inwardly, by an edge S, preferably forming a right angle, defined by a radially oriented first flat annular surface 19 substantially parallel to the first face 18, and an axially oriented second flat annular surface 20 delimiting the annular body 11 radially on the inside.

The second annular surface 20 is configured to define, when in use, the aforementioned predetermined radial gap 15 with the inner ring 3 of the bearing, being parallel to and facing the radially outer lateral surface 14 thereof.

The radially inner axially curved portion 16 of the radially inner peripheral edge 13 of the annular body 11 is also delimited, radially on the outside and towards the radially outer peripheral edge 12 of the annular body 11, by a third annular surface 21 (FIGS. 3 and 5), arranged obliquely with respect to the first and second annular surfaces 19 and 20 and defining a substantially flat intrados side of the radially inner axially curved portion 16 of the radially inner peripheral edge 13 of the annular body 11.

In addition, the radially inner axially curved portion 16 of the radially inner peripheral edge 13 of the annular body 11 has an extrados side, opposite the third annular surface 21, defined by a curved annular surface 22, preferably forming a circular arc in radial section and arranged so as to at least partially face the radially outer lateral surface 14 at the end 8.

The radially outer peripheral edge 12 of the annular body 11 constituting the sealing shield 6 comprises (FIGS. 3, 4 and 6), radially inwards, a first annular portion 23 forming an annular spur 23b that extends axially cantilevered from the substantially flat first face 18 of the annular body 11.

According to one aspect of the present disclosure, the annular spur 23b has a radially outer lateral surface 24 which is substantially cylindrical and coaxial with the axis A of symmetry of the annular body 11 and the sealing shield 6, and an opposite radially inner lateral surface 25 arranged obliquely with respect to the axis A of symmetry so as to converge towards the axis A on the side opposite the side with the face 18.

The lateral surface 25 is therefore a conical surface coaxial with the axis A, tapering towards the side opposite the side with the face 18, where “taper” refers to the direction in which the generating line of the conical surface 25 meets the axis A in order to rotate about it.

According to one aspect of the present disclosure, the face 18 has a substantially channel-shaped annular recess 26 in the radially inner conical lateral surface 25 of the annular spur 23b.

The annular recess 26 is delimited by a curved bottom wall 27, which is connected continuously to the radially inner conical lateral surface 25 of the annular spur 23b.

The annular recess 26 is also configured to extend radially, in part, within an annular root or base portion 28 of the annular spur 23b.

The bottom wall 27 of the annular recess 26 preferably has an inverted teardrop profile in radial cross-section, i.e. radially oriented with one end 29 thereof, corresponding to the thinned end of one teardrop, facing radially inwards.

According to a further aspect of the present disclosure, the radially outer peripheral edge 12 of the annular body 11 also comprises a second annular portion 30, immediately adjacent to the spur-shaped first annular portion 23 and extending radially on the outside from the annular spur 23b.

The annular portion 30 of the annular body 11 is also configured to be axially offset from the first face 18 in the direction of axial extension of the annular spur 23b.

The second annular portion 30 (FIGS. 3 and 5) is provided, on the same side as said first face 18, with an annular sealing relief 31 with a curvilinear profile in radial section that extends axially in cantilever from the second annular portion 30, on the same side as the annular spur 23b.

In addition, the annular relief 31 is spaced apart radially on the outside from the annular spur 23b and is configured to couple when in use with a corresponding annular groove 32 (FIG. 6) of conjugate radial profile, formed in the annular seat 10 of the outer ring 2.

According to another aspect of the present disclosure, the radially outer peripheral edge 12 of the annular body 11 finally comprises a radially outermost third annular portion 33 immediately adjacent to the second annular portion 30.

The third annular portion 33 is radially delimited on the outside by a rounded annular head 34. Radially on the inside of the annular head 34, the annular portion 33 is provided with a second annular relief 35, shaped like a goose beak, protruding axially from the third annular portion 33 on the side opposite the side with the face 18 and the annular relief 31.

The third annular portion 33 of the radially outer peripheral edge 12 of the annular body 11 (FIG. 4) is also provided with a plurality of radial notches 36 which extend circumferentially at a constant pitch and radially up to the immediate vicinity of the annular sealing relief 31 of the second annular portion 30.

These radial notches 36 make the radially outer edge 12 partially elastically flexible at the radially outermost annular portion 33 thereof, to enable the shield 6 and the seat 10 to be coupled by snap-fitting when in use.

From the foregoing, it is clear that a rolling bearing 1 of any type, as described above, comprising at least one (in the example shown, two) sealing shield 6 is also part of the present disclosure, in which the sealing shield 6 is a single annular part made of a single synthetic non-elastomeric thermoplastic plastic material and which engages the annular seat 10 with its radially outer peripheral edge 12, comprising the three annular portions 23, 30 and 33 described above, which are arranged radially in series from the spur-shaped radially innermost annular portion 23 to the radially outermost annular portion 33 via the radially intermediate annular portion 30, wherein:
a) the radially innermost first annular portion 23 is provided with the annular spur 23b projecting axially cantilevered from the face 18 of the sealing shield 6 facing the rolling elements 4 and delimited by the radially outer lateral surface 24 coaxial with the axis A of symmetry of the sealing shield 6 and arranged near to, but radially offset from, a radially inner lateral wall 38 (FIG. 6) of the outer ring 3 immediately adjacent to the annular seat 10; the annular portion 23 also being delimited by an opposing, radially inner conical lateral surface 25 tapering towards the side opposite the side with the first face 18. The conical surface 25 is also configured to face the rolling elements 4 when in use;
b) the second annular portion 30 immediately adjacent to and radially on the outside of the annular portion 23, is provided with an annular sealing relief 31 with a curvilinear radial profile engaged in a fluid-tight manner in the annular groove 32 of conjugate shape formed in the outer ring 2 within the annular seat 10; and
c) the radially outermost third annular portion 33, immediately adjacent to the second annular portion 30, is delimited radially on the outside by the rounded annular head 34, which is coupled to a corresponding rounded portion 39 of the annular seat 10; the third annular portion 33 being provided radially on the inside with a second annular relief 35 shaped like a goose beak, which protrudes axially from the side opposite the side with the first face 18 and the sealing relief 31; said third annular portion 33 being provided with a plurality of radial notches 36 extending circumferentially and radially to the immediate vicinity of the annular sealing relief 31.

The goose-beak annular relief 35 is coupled in abutment against an end edge 40 of the annular seat 10, opposite the annular groove 32.

As described above, the face 18 of the sealing shield 6 has, at the radially inner lateral surface 25 of the annular spur 23b, an annular recess 26 whose bottom wall 27 is connected continuously to the radially inner lateral surface 25 of the annular spur 23b and which extends partly radially within the root portion 28 of the annular spur 23b.

As described above, the radially inner peripheral edge 13 of the sealing shield 6 comprises a radially inner curved portion 16 axially delimited on the same side as the face 18:

radially inwards by the edge S defined by the radially oriented, flat annular surface 19 and the axially oriented flat annular surface 20 that radially delimits the sealing shield 6 on the inside, said annular surface 20 facing the radially outer lateral surface 14 of the inner ring 3 to form therewith a predetermined radial gap 15, preferably not greater than 2 tenths of a mm, defining a labyrinth seal;

radially outwards by the annular surface 21, which faces the annular spur 23b and is arranged obliquely to the annular surfaces 19 and 20, so as to converge towards the inner ring 3 on the same side as the rolling elements 4, to define the substantially flat intrados side of the radially inner axially curved portion 16 of the radially inner peripheral edge 13 of the annular sealing shield 6.

a) A 50% reduction in the clearance between the diameter of the shoulder of the inner ring 3 defined by (or by part of) the lateral surface 14 and the inner diameter of the annular shield 6, using an injection moulding process, which is more accurate than the plastic deformation moulding process used to make known metal sealing shields. This feature reduces the loss of grease from the inner ring 3.

b) A labyrinth geometry created by the lateral wall 24 of the rib formed by the annular spur 23b, arranged just at the diameter of the shoulder of the outer ring 2 formed by (or by part of) the lateral wall 38, to eliminate/reduce grease loss from the outer ring 2, which is also hindered by the sealing relief 31 coupled in the groove 32.

Additionally: (1) The injection moulding process generates no waste, as 100% of the plastics material can be reused. (2) The gap 15 can be reduced to a minimum, on account of the reduced risk of contact. This offers advantages in terms of reduced grease loss and increased protection from external contaminants. (3) The outer rib formed by the annular spur 23b located right next to the anchor point to the outer ring 2 formed by the outermost annular portions 30 and 33 of the edge 12 reduces the risk of losses through the anchor point, in particular for applications in which the outer ring 2 is rotary. (4) The final product (annular shield 6) is 100% recyclable at end of life. (5) An estimated reduction in CO₂ emissions of more than 50% is obtained over the entire production/life cycle of the sealing shield 6 compared to a sealing shield made of steel using the current steel processing system.

All the objectives of the present disclosure are therefore achieved.

What is claimed is:

1. A sealing shield for a rolling bearing having an outer ring and an inner ring, the sealing shield comprising:
an annular body having a radially outer peripheral edge and a radially inner peripheral edge, the radially outer peripheral edge being configured to mate integrally to the outer ring of the bearing, the radially inner peripheral edge being configured to form a labyrinth seal with a radially outer lateral surface of the inner ring of the bearing and to define a predetermined radial gap with the radially outer lateral surface of the inner ring, the annular body is made entirely in one piece and of a single thermoplastic non-elastomeric synthetic plastic material, the radially outer peripheral edge being configured to snap-fit mate in a substantially fluid-tight manner with an annular seat formed radially on the inside of the outer ring of the bearing.

2. The sealing shield according to claim 1, wherein the annular body is made of a thermoplastic material selected from the group consisting of: PP (polypropylenes), PBT (polybutylenes), TPC (polyesters), PA66, and PA46, and wherein the annular body is substantially disk-shaped and has an axial thickness and an outer diameter, wherein a ratio between the axial thickness and the outer diameter is between 1/50 and 1/30.

3. The sealing shield according to claim 1, wherein the annular body has a substantially flat first face configured to face toward an inner space of the bearing bounded between the inner and outer rings, the radially inner peripheral edge has a radially inner axially curved portion so as to project axially cantilevered from the first face, the radially inner axially curved portion being bounded on the side of said first face and radially inward by an edge, the edge defined by a first flat annular surface radially oriented and substantially parallel to the first face and defined by a second flat annular surface axially oriented and radially bounding on the inside the annular body, the second annular surface being configured to define the predetermined radial gap, the radially inner axially curved portion being further bounded radially on the outside and toward the radially outer peripheral edge by a third annular surface, the third annular surface being arranged obliquely to the first and second annular surfaces and defining a substantially flat intrados side of the radially inner axially curved portion.

4. The sealing shield according to claim 3, wherein the radially inner axially curved portion has an extrados side that is opposite the third annular surface and is defined by a curved annular surface.

5. The sealing shield according to claim 1, wherein the annular body has a substantially flat first face configured to face toward an inner space of the bearing bounded between the inner and outer rings, wherein the radially outer peripheral edge comprises a first radially inwardly annular portion, the first annular portion comprising an annular spur extending axially cantilevered from the first face of the annular body, the annular spur having a radially outer lateral surface that is substantially cylindrical and coaxial with an axis of symmetry of the annular body, the annular spur having an opposite radially inner lateral surface arranged obliquely to the axis of symmetry so as to converge toward the axis of symmetry on the side opposite to said first face, the annular body having an annular recess at the radially inner lateral surface of the annular spur, the annular recess having a bottom wall connecting with continuity with the radially inner lateral surface of the annular spur, the annular spur having a root portion, the bottom wall of the annular recess extending in part radially within the root portion of the annular spur.

6. The sealing shield according to claim 5, wherein the bottom wall of the annular recess has in radial section a radially oriented teardrop profile with a thinned end facing radially inward.

7. The sealing shield according to claim 5, wherein the radially outer peripheral edge comprises a second annular portion immediately adjacent to said first annular portion and extending radially outwardly from the annular spur, the second annular portion being axially misaligned from said first face in a direction of axial extension of the annular spur, the annular body having an annular sealing relief having a curvilinear profile in radial section and extending axially cantilevered from the second annular portion on the same side of the annular body of said annular spur, the annular sealing relief being radially spaced apart on the outside from the annular spur, the annular sealing relief being configured to mate with an annular groove of radial profile conjugate to the annular sealing relief in the annular seat of the outer ring.

8. The sealing shield according to claim 7, wherein the radially outer peripheral edge comprises a third annular portion, the third annular portion being radially outer and immediately adjacent to the second annular portion, the third annular portion being delimited radially on the outside by a rounded annular head, the rounded annular head having a second annular relief radially on the inside of the rounded annular head, the second annular relief being shaped like a goose beak, the second annular relief protruding axially on the side of the annular body that is opposite to the first face and the annular sealing relief, the third annular portion having a plurality of radial notches extending circumferentially with constant pitch and radially up to the immediate adjacency of the annular sealing relief.

9. The sealing shield according to claim 1, wherein the whole sealing shield is made entirely in one piece.

10. The sealing shield according to claim 2, wherein the annular body has a substantially flat first face configured to face toward an inner space of the bearing bounded between the inner and outer rings, the radially inner peripheral edge has a radially inner axially curved portion so as to project axially cantilevered from the first face, the radially inner axially curved portion being bounded on the side of said first face and radially inward by an edge, the edge defined by a first flat annular surface radially oriented and substantially parallel to the first face and defined by a second flat annular surface axially oriented and radially bounding on the inside the annular body, the second annular surface being configured to define the predetermined radial gap, the radially inner axially curved portion being further bounded radially on the outside and toward the radially outer peripheral edge by a third annular surface, the third annular surface being arranged obliquely to the first and second annular surfaces and defining a substantially flat intrados side of the radially inner axially curved portion.

11. The sealing shield according to claim 10, wherein the radially inner axially curved portion has an extrados side that is opposite the third annular surface and is defined by a curved annular surface.

12. The sealing shield according claim 11, wherein the radially outer peripheral edge comprises a first radially inwardly annular portion, the first annular portion comprising an annular spur extending axially cantilevered from the first face of the annular body, the annular spur having a radially outer lateral surface that is substantially cylindrical and coaxial with an axis of symmetry of the annular body, the annular spur having an opposite radially inner lateral surface arranged obliquely to the axis of symmetry so as to converge toward the axis of symmetry on the side opposite to said first face, the annular body having an annular recess at the radially inner lateral surface of the annular spur, the annular recess having a bottom wall connecting with continuity with the radially inner lateral surface of the annular spur, the annular spur having a root portion, the bottom wall of the annular recess extending in part radially within the root portion of the annular spur.

13. The sealing shield according to claim 12, wherein the bottom wall of the annular recess has in radial section a radially oriented teardrop profile with a thinned end facing radially inward.

14. The sealing shield according to claim 13, wherein the radially outer peripheral edge comprises a second annular portion immediately adjacent to said first annular portion and extending radially outwardly from the annular spur, the second annular portion being axially misaligned from said first face in a direction of axial extension of the annular spur, the annular body having an annular sealing relief having a curvilinear profile in radial section and extending axially cantilevered from the second annular portion on the same side of the annular body of said annular spur, the annular sealing relief being radially spaced apart on the outside from the annular spur, the annular sealing relief being configured to mate with an annular groove of radial profile conjugate to the annular sealing relief in the annular seat of the outer ring.

15. The sealing shield according to claim 14,
wherein the radially outer peripheral edge comprises a third annular portion, the third annular portion being radially outer and immediately adjacent to the second annular portion, the third annular portion being delimited radially on the outside by a rounded annular head, the rounded annular head having a second annular relief radially on the inside of the rounded annular head, the second annular relief being shaped like a goose beak, the second annular relief protruding axially on the side of the annular body that is opposite to the first face and the annular sealing relief, the third annular portion having a plurality of radial notches extending circumferentially with constant pitch and radially up to the immediate adjacency of the annular sealing relief.

16. The sealing shield according to claim 15, wherein the whole sealing shield is made entirely in one piece.

17. A rolling bearing comprising:
a radially outer ring, the outer ring having an axial end and an annular seat at the axial end, the annular seat being disposed on a radial inside of the outer ring, the outer ring having a radially inner lateral wall immediately adjacent to the annular seat, the outer ring having an annular groove within the annular seat, the annular seat having an edge opposite to the annular groove, the annular seat having a rounded portion;
a radially inner ring;
a plurality of rolling elements interposed between the inner and outer rings to enable the outer and inner rings to be rotatable relative to one another;
a retaining cage for the rolling elements; and
at least one sealing shield interposed between the inner and outer rings at an axial end of the inner and outer rings, the sealing shield being made in one piece having an annular shape as a discoidal annular body, the sealing shield being made of a single thermoplastic, non-elastomeric synthetic material, the sealing shield having a first face facing the rolling elements, the sealing shield having a radially outer peripheral edge engaging the annular seat of the outer ring, the radially outer peripheral edge comprising:
a first radially inner annular portion having an annular spur extending axially cantilevered from the first face of the sealing shield, the annular spur having a radially outer lateral surface coaxial with an axis of symmetry of the sealing shield, the radially outer lateral surface being disposed near to, but radially offset from, the radially inner lateral wall of the outer ring, the annular spur having an opposing radially inner conical lateral surface having a taper facing on the side opposite to said first face and facing said rolling elements;
a second annular portion immediately adjacent to the first annular portion, the second annular portion being radially on the outside of the first annular portion, the second annular portion having an annular relief, the annular relief having a curvilinear radial profile, the annular relief being engaged substantially fluid-tight in the annular groove of the outer ring, the annular groove of the outer ring being of conjugate shape to the annular relief; and
a third radially outer annular portion immediately adjacent to the second annular portion, the third annular portion being bounded radially on the outside by a rounded annular head coupled with the rounded portion of the annular seat, the rounded annular head having a second annular relief radially on the inside of the rounded annular head, the second annular relief being shaped like a goose beak, the second annular relief protruding axially on the side of the annular body that is opposite the first face and the annular relief, the third annular portion having a plurality of radial notches extending circumferentially and radially up to the immediate adjacency of the annular relief of the second annular portion, the second annular relief shouldering against the end edge of the annular seat.

18. The rolling bearing according to claim 17, wherein the first face of the sealing shield has an annular recess at the radially inner lateral surface of the annular spur, the annular recess having a bottom wall connecting continuously with the radially inner lateral surface of the annular spur, the annular spur having a root portion, the bottom wall of the annular recess extending in part radially within the root portion of the annular spur.

19. The sealing shield according to claim 18, wherein the bottom wall of the annular recess has in radial section a radially oriented teardrop profile with a thinned end facing radially inward.

20. The rolling bearing according to claim 19, wherein the inner ring has a radially outer lateral surface, wherein the sealing shield has a radially inner peripheral edge, the radially inner peripheral edge comprising a radially inner axially curved portion;
wherein the radially inner axially curved portion is bounded radially inward on the side of the first face by an edge, the edge being defined by a first radially oriented flat annular surface and by a second flat annular surface that is axially oriented and radially delimiting on the inside the sealing shield, the second annular surface facing the radially outer lateral surface of the inner ring, the second annular surface of the sealing shield and the radially outer lateral surface of the inner ring defining a radial gap therebetween forming a labyrinth seal;
wherein the radially inner axially curved portion being bounded radially outward on the side of the first face by a third annular surface, the third annular surface facing the annular spur, the third annular surface being arranged obliquely to the first and second annular surfaces, the third annular surface defining a substantially flat intrados side of the radially inner axially curved portion of the radially inner peripheral edge of the sealing shield.

21. The rolling bearing according to claim 17, wherein the inner ring has a radially outer lateral surface, wherein the sealing shield has a radially inner peripheral edge, the radially inner peripheral edge comprising a radially inner axially curved portion;
wherein the radially inner axially curved portion is bounded radially inward on the side of the first face by an edge, the edge being defined by a first radially oriented flat annular surface and by a second flat annular surface that is axially oriented and radially delimiting on the inside the sealing shield, the second annular surface facing the radially outer lateral surface of the inner ring, the second annular surface of the sealing shield and the radially outer lateral surface of the inner ring defining a radial gap therebetween forming a labyrinth seal;
wherein the radially inner axially curved portion being bounded radially outward on the side of the first face by a third annular surface, the third annular surface facing the annular spur, the third annular surface being arranged obliquely to the first and second annular surfaces, the third annular surface defining a substantially flat intrados side of the radially inner axially curved portion of the radially inner peripheral edge of the sealing shield.
